(19) United States
(12) Patent Application Publication
(10) Pub. No.: US 2026/0371326 A1
(43) Pub. Date: Nov. 19, 2026

(54) BASE STATION, TERMINAL, AND COMMUNICATION METHOD

(71) Applicant: Panasonic Intellectual Property Corporation of America, Torrance, CA (US)

(72) Inventors: Tomoya NUNOME, Ishikawa (JP); Hidetoshi SUZUKI, Kanagawa (JP); Ayako HORIUCHI, Kanagawa (JP)

(73) Assignee: Panasonic Intellectual Property Corporation of America, Torrance, CA (US)

(21) Appl. No.: 19/155,379

(22) PCT Filed: Oct. 19, 2023
(86) PCT No.: PCT/JP2023/037876

§ 371 Date: Aug. 11, 2025

(30) Foreign Application Priority Data
Feb. 15, 2023 (JP) 2023-021552

(51) Int. Cl. H04W 72/0453

(52) U.S. Cl. CPC H04W 72/0453

(57) ABSTRACT

A base station of a form in which a transmission direction is set for each of a plurality of bands obtained by dividing a frequency band, the base station comprising a control circuit that causes resource allocation to vary in accordance with whether a first band corresponding to a first transmission direction is disposed discontinuously in a physical resource block, and a transmission circuit that transmits a signal in accordance with the resource allocation.

### TECHNICAL FIELD

The present disclosure relates to a base station, a terminal, and a communication method.

### BACKGROUND ART

In 3rd Generation Partnership Project (3GPP), the specification of the physical layer in Release 17 New Radio access technology (NR) has been completed as functional extension of 5th Generation mobile communication systems (5G). NR supports functions for realizing Ultra Reliable and Low Latency Communication (URLLC) in addition to enhanced Mobile Broadband (eMBB) to satisfy requirements of high speed and high capacity (see, e.g., Non-Patent Literatures (hereinafter referred to as “NPLs”) 1 to 5).

### CITATION LIST

### Non-Patent Literature

NPL 1
3GPP TS 38.211 V17.4.0, “NR; Physical channels and modulation (Release 17),” December 2022
NPL 2
3GPP TS 38.212 V17.4.0, “NR; Multiplexing and channel coding (Release 17),” December
NPL 3
3GPP TS 38.213 V17.4.0, “NR; Physical layer procedure for control (Release 17),” December 2022
NPL 4
3GPP TS 38.214 V17.4.0, “NR; Physical layer procedures for data (Release 17),” December 2022
NPL 5
3GPP TS 38.331 V17.3.0, “NR; Radio Resource Control (RRC) protocol specification (Release 17)”, December 2022

### SUMMARY OF INVENTION

However, there is room for improvement in a resource allocation method in radio communication.

One non-limiting and exemplary embodiment facilitates providing a base station, a terminal, and a communication method each capable of appropriately performing resource allocation in radio communication.

A base station according to one exemplary embodiment of the present disclosure includes: control circuitry, which, in operation, causes resource allocation to vary depending on whether a first band corresponding to a first transmission direction is non-contiguously arranged in a physical resource block, in a scheme in which a transmission direction is configured for each of a plurality of bands into which a frequency band is divided; and transmission circuitry, which, in operation, transmits a signal in accordance with the resource allocation.

It should be noted that general or specific embodiments may be implemented as a system, an apparatus, a method, an integrated circuit, a computer program, a storage medium, or any selective combination thereof.

According to one exemplary embodiment of the present disclosure, it is possible to appropriately perform resource allocation in radio communication.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates examples of a duplex system;

FIG. 2 illustrates an example of a subband and a guardband in subband non-overlapping full duplex (SBFD).

FIG. 3 is a block diagram illustrating an exemplary configuration of a part of a base station;

FIG. 4 is a block diagram illustrating an exemplary configuration of a part of a terminal;

FIG. 5 is a block diagram illustrating an exemplary configuration of the base station;

FIG. 6 is a block diagram illustrating an exemplary configuration of the terminal;

FIG. 7 is a sequence diagram illustrating an exemplary operation of the base station and the terminal;

FIG. 8 illustrates a mapping example of a virtual resource block (VRB) and a physical resource block (PRB);

FIG. 9 illustrates a mapping example of the VRB and the PRB;

FIG. 10 illustrates a mapping example of the VRB and the PRB;

FIG. 11 illustrates a mapping example of the VRB and the PRB;

FIG. 12 illustrates an example of resource allocation;

FIG. 13 illustrates an example of an association between a resource indication value (RIV) and the resource allocation;

FIG. 14 illustrates an example of the resource allocation;

FIG. 15 illustrates an exemplary architecture of a 3GPP NR system;

FIG. 16 is a schematic diagram illustrating functional split between Next Generation-Radio Access Network (NG-RAN) and 5th Generation Core (5GC);

FIG. 17 is a sequence diagram of a Radio Resource Control (RRC) connection setup/reconfiguration procedure;

FIG. 18 is a schematic diagram illustrating usage scenarios of enhanced mobile broadband (eMBB), massive machine type communications (mMTC), and ultra reliable and low latency communications (URLLC); and

FIG. 19 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

### [Regarding Subband Non-Overlapping Full Duplex (SBFD)]

The “Study on evolution of NR duplex operation” was approved as a Study Item for Release 18. One of the main topics of the Study Item is the support for subband non-overlapping full duplex (SBFD, also referred to as Cross Division Duplex (XDD)).

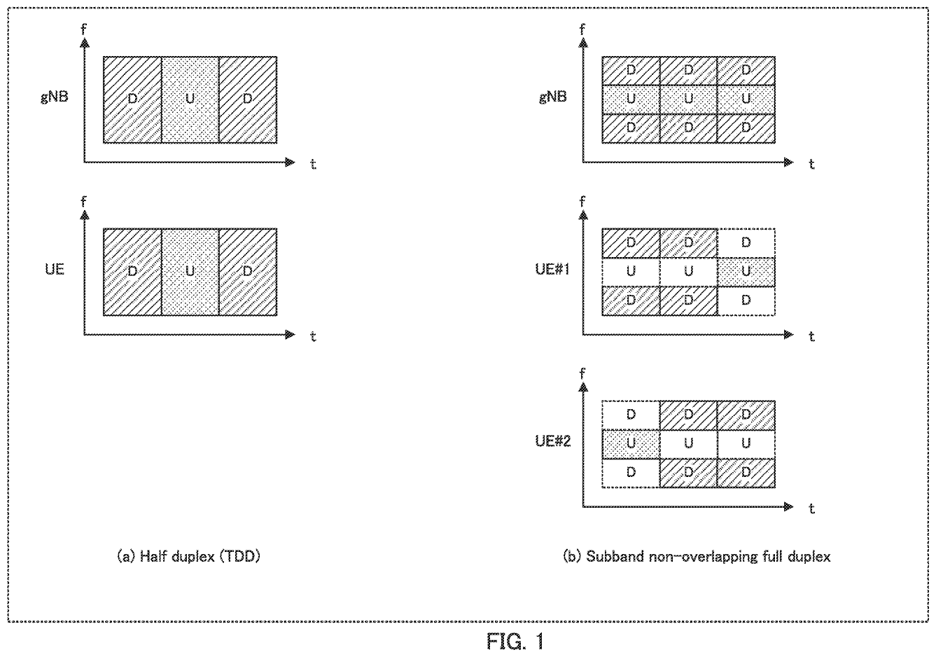

Parts (a) to (c) in FIG. 1 illustrate examples of a Duplex system. In parts (a) to (c) in FIG. 1, the vertical axis represents frequency, and the horizontal axis represents time. Further, “U” indicates uplink transmission and “D” indicates downlink transmission in parts (a) to (c) in FIG. 1.

Part (a) in FIG. 1 illustrates an example of Time Division Duplex (TDD) in half duplex. In part (a) in FIG. 1, a terminal (for example, also referred to as user equipment (UE)) is a terminal connected to a base station (for example, also referred to as gNB). In the half duplex illustrated at part (a) in FIG. 1, the transmission direction (for example, downlink or uplink) in a certain time resource may be common between the base station and the terminal. For example, the transmission direction is not different between terminals in a certain time resource.

Part (b) in FIG. 1 illustrates an example of SBFD. In SBFD, a frequency resource (or frequency band) is divided into multiple bands (also referred to, for example, as subbands, RB sets, sub-bands, sub-BandWidth Parts (sub-BWPs)), and transmission in different directions (for example, downlink or uplink) on a subband-by-subband basis is supported. Note that, in SBFD, a terminal performs either uplink or downlink transmission and reception in a certain time resource, and does not perform transmission and reception of the other. In contrast, in SBFD, the base station can simultaneously transmit and receive both the uplink and the downlink. Note that there may be a case where a terminal does not use a resource in the transmission direction in a certain time resource (for example, a resource indicated by a broken line at part (b) in FIG. 1).

Although not illustrated in FIG. 1, a guardband may be arranged between an uplink subband (UL subband: U) and a downlink subband (DL subband: D). The guardband may be used to reduce interference (cross link interference (CLI)) between different transmission directions (links).

In the following description, a subband configuration is denoted as {X . . . X}. X represents an UL subband (U) or a DL subband (D). The order of notation corresponds to the order of arrangement of the subbands. For example, the subband configuration at part (b) in FIG. 1 is denoted as {DUD}.

### [Resource Allocation Method]

Resource allocation Type 1 (RA type 1) is one example of a resource allocation method for a data channel. RA type 1 is used, for example, for allocating contiguous resources.

For example, the following two parameters may be used to indicate the resource allocation using RA type 1.
RBₛₜₐᵣₜ: the resource block (RB) number at which the resource allocation starts
L_{RB}: the length (for example, the number of RBs) of RBs to be allocated contiguously

These parameters may be combined into a single value, referred to as a resource indication value (RIV), for example, using the following equation. In the following equation, N_{BWP}^{size} represents the number of physical resource blocks (PRBs) in a bandwidth part (BWP).

$$If ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} - 1 ) + ( {N}_{BWP}^{size} - 1 - {RB}_{start} )$$

$$where {L}_{Rbs} \geq 1 and shall not exceed {N}_{BWP}^{size} - {RB}_{start}$$

In addition, in the resource allocation, VRB-to-PRB mapping may be applied in addition to RA type 1.

In the VRB-to-PRB mapping, mapping from a virtual resource block (VRB) to a physical resource block (PRB) is performed. As the mapping method, there may be mapping to which interleaving is applied (Interleaved VRB-to-PRB mapping) and mapping to which interleaving is not applied (Non-interleaved VRB-to-PRB mapping).

In the Non-interleaved VRB-to-PRB mapping, the VRB and the PRB may be the same. For example, VRB #n may be mapped to PRB #n (n indicates an RB number).

In the Interleaved VRB-to-PRB mapping, the VRB is mapped to the PRB via an interleaver. Therefore, in a case where RA type 1 and the Interleaved VRB-to-PRB mapping are used for the resource allocation, the allocation is contiguous in the VRB, but the resource allocation may be non-contiguous in the PRB.

As an example, a case where RA type 1 and the VRB-to-PRB mapping are applied in SBFD will be described. In SBFD, for example, the DL subbands can be non-contiguously arranged as in {DUD}. For example, an example of performing resource allocation of a data channel (for example, a physical downlink shared channel (PDSCH)) in the DL subband will be described.

In a case where RA type 1 and the Non-interleaved VRB-to-PRB mapping are used, since the resource allocation is for contiguous PRBs, it is difficult to allocate resources simultaneously to a plurality of non-contiguous DL subbands.

In addition, in a case where RA type 1 and the interleaved VRB-to-PRB mapping are used, it is possible to allocate resources to non-contiguous PRBs, but since the positions of the PRBs to be allocated with resources depend on the interleaver, it may be difficult to select VRB positions such that the resources are not allocated on the UL subband.

### [Size of Guardband]

The guardband may be used to reduce the leakage of CLI from an adjacent subband.

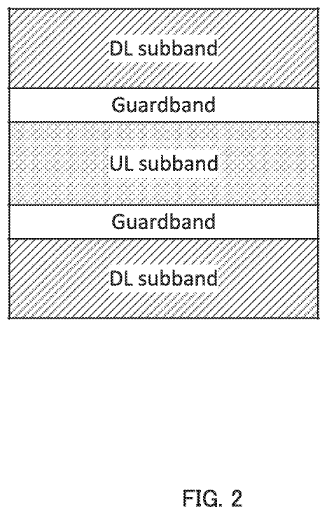

FIG. 2 illustrates an example of a guardband in a subband configuration of {DUD}. The size of the guardband to be configured may vary depending on, for example, the magnitude of the CLI. For example, it is expected that a wide guardband (for example, a guardband with a large number of RBs) is configured in a case where the CLI is large, and there is a possibility that a narrow guardband (for example, a guardband with a small number of RBs) is sufficient in a case where the CLI is small.

Here, for example, the inter-terminal interference may vary depending on a combination of terminals transmitting and receiving signals, the CLI is not necessarily constant, and thus the required guardband size may vary dynamically. Therefore, it is assumed that the resources can be efficiently used by dynamically configuring (or changing/adjusting) the guardband size according to the CLI. There are, for example, the following methods for dynamically adjusting the size of the guardband by the resource allocation.

### <Adjustment Method 1 for Guardband Size>

Adjustment Method 1 is a method of not allocating the transmission/reception resource to an RB (for example, one or a plurality of RBs) adjacent to another subband in the DL subband or the UL subband.

By using as the guardband the RB that is not used for transmission and reception, the guardband can be substantially widened. Since Adjustment Method 1 is, for example, a method of widening the size of the guardband, the guardband size configured in advance (or defined) may be small.

### <Adjustment Method 2 for Guardband Size>

Adjustment Method 2 is a method of allocating a DL resource or a UL resource to the RB within the guardband.

In a case where the DL resource is allocated to the guardband, the RB (for example, one or a plurality of RBs) in the guardband adjacent to the DL subband is allocated. In addition, in a case where the UL resource is allocated to the guardband, the RB (for example, one or a plurality of RBs) in the guardband adjacent to the UL subband is allocated. Since Adjustment Method 2 is, for example, a method of narrowing the size of the guardband, the guardband size configured in advance (or defined) may be wide.

The size of the guardband has been described above.

In one non-limiting and exemplary embodiment of the present disclosure, a resource allocation method in SBFD will be described.

### [Overview of Communication System]

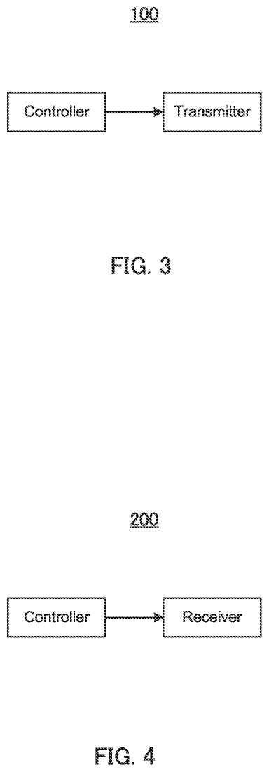

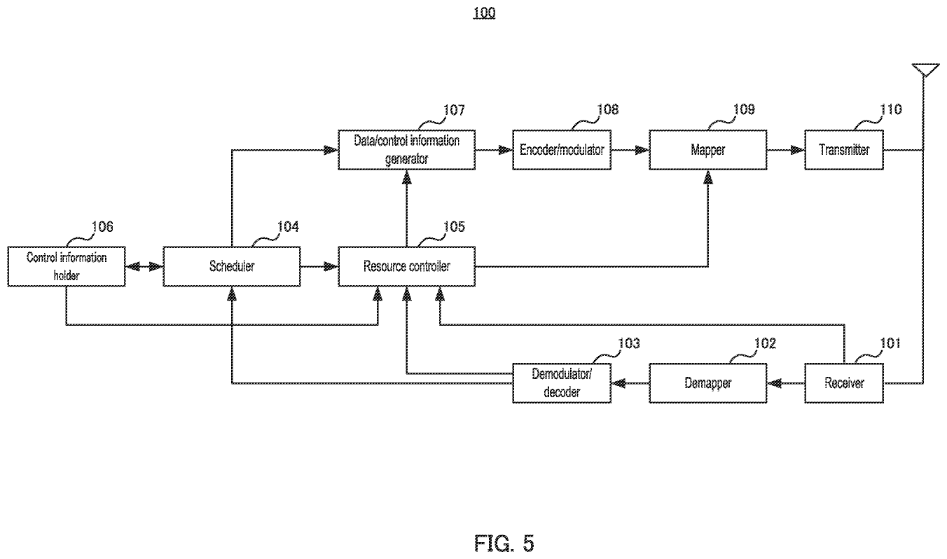

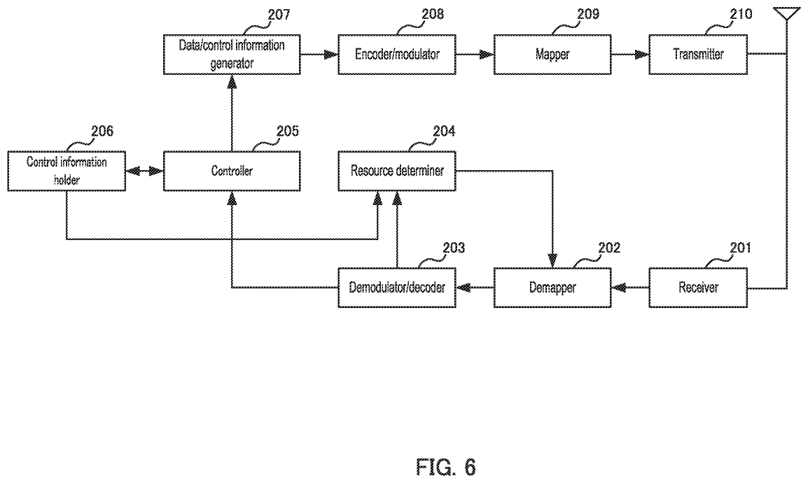

A communication system according to one aspect of the present disclosure may include, for example, base station 100 (for example, gNB) illustrated in FIGS. 3 and 5 and terminal 200 (for example, UE) illustrated in FIGS. 4 and 6. The communication system may include a plurality of base stations 100 and a plurality of terminals 200.

FIG. 3 is a block diagram illustrating an exemplary configuration of a part of base station 100 according to one aspect of the present disclosure. In base station 100 illustrated in FIG. 3, in a scheme (for example, SBFD) in which a transmission direction is configured for each of a plurality of bands into which a frequency band is divided, a controller (for example, corresponding to control circuitry) causes resource allocation to vary depending on whether a first band corresponding to a first transmission direction is non-contiguously arranged in a physical resource block. A transmitter (for example, corresponding to transmission circuitry) transmits a signal in accordance with the resource allocation.

FIG. 4 is a block diagram illustrating an exemplary configuration of a part of terminal 200 according to one aspect of the present disclosure. In terminal 200 illustrated in FIG. 4, in a scheme (for example, SBFD) in which a transmission direction is configured for each of a plurality of bands into which a frequency band is divided, a controller (for example, corresponding to control circuitry) causes resource allocation to vary depending on whether a first band corresponding to a first transmission direction is non-contiguously arranged in a physical resource block. A receiver (for example, reception circuitry) receives a signal in accordance with the resource allocation.

### [Configuration of Base Station]

FIG. 5 is a block diagram illustrating an exemplary configuration of base station 100 according to one aspect of the present disclosure. In FIG. 5, base station 100 includes receiver 101, demapper 102, demodulator/decoder 103, scheduler 104, resource controller 105, control information holder 106, data/control information generator 107, encoder/modulator 108, mapper 109, and transmitter 110.

For example, at least one of demapper 102, demodulator/decoder 103, scheduler 104, resource controller 105, control information holder 106, data/control information generator 107, encoder/modulator 108, and mapper 109 may be included in the controller illustrated in FIG. 3, and transmitter 110 may be included in the transmitter illustrated in FIG. 3.

Receiver 101 performs, for example, reception processing such as down-conversion or A/D conversion on a received signal received via an antenna, and outputs the received signal after the reception processing to demapper 102. In addition, receiver 101 measures an interference level from a downlink signal to an uplink signal, and outputs information on a measurement result (for example, referred to as DL-UL interference information) to resource controller 105.

Demapper 102 performs resource demapping on the received signal (for example, the uplink signal) input from receiver 101, and outputs a modulated signal to demodulator/decoder 103.

Demodulator/decoder 103 demodulates and decodes, for example, the modulated signal input from demapper 102, and outputs a decoding result to scheduler 104. In addition, in a case where, for example, the decoding result includes UL-DL interference information (for example, information on an interference level from an uplink to a downlink measured by terminal 200), demodulator/decoder 103 outputs the UL-DL interference information to resource controller 105.

Scheduler 104 may perform scheduling for terminal 200, for example. Scheduler 104 performs, for example, scheduling of transmission and reception of each terminal 200 based on at least one of the decoding result input from demodulator/decoder 103 and the control information input from control information holder 106, and gives data/control information generator 107 an instruction to generate at least one of data and control information. In addition, scheduler 104 may output scheduling information to resource controller 105. Furthermore, scheduler 104 may output control information on scheduling for terminal 200 to control information holder 106.

Resource controller 105 may determine the size of the guardband based on the DL-UL interference information input from receiver 101, the UL-DL interference information input from demodulator/decoder 103, and the scheduling information input from scheduler 104. In addition, for example, resource controller 105 determines a resource to be used for downlink transmission by each terminal 200 based on the control information input from control information holder 106, the scheduling information input from scheduler 104, and the determined guardband size, and outputs resource allocation information to data/control information generator 107 and mapper 109.

Control information holder 106 holds, for example, control information configured for each terminal 200. The control information may include, for example, configuration of a downlink data channel for each terminal 200 (for example, information on SBFD or resource allocation). Control information holder 106 may output, for example, the held information to each component (for example, scheduler 104 and resource controller 105) of base station 100, as needed.

Data/control information generator 107 generates, for example, at least one of data and control information in accordance with the indication from scheduler 104 and outputs a signal including the generated data or control information to encoder/modulator 108. Data/control information generator 107 may generate, for example, the control information for terminal 200 based on the resource allocation information input from resource controller 105.

Encoder/modulator 108 encodes and modulates, for example, the signal input from data/control information generator 107 (for example, data and control information), and outputs the modulated signal to transmitter 110.

Mapper 109 performs, for example, resource mapping on the modulated signal input from encoder/modulator 108 based on the resource allocation information input from resource controller 105, and outputs the transmission signal to transmitter 110.

Transmitter 110 performs, for example, transmission processing such as D/A conversion, up-conversion, or amplification on the signal input from mapper 109, and transmits the radio signal obtained by the transmission processing to terminal 200 from the antenna.

### [Configuration of Terminal]

FIG. 6 is a block diagram illustrating an exemplary configuration of terminal 200 according to one aspect of the present disclosure. In FIG. 6, terminal 200 includes receiver 201, demapper 202, demodulator/decoder 203, resource determiner 204, controller 205, control information holder 206, data/control information generator 207, encoder/modulator 208, mapper 209, and transmitter 210.

For example, at least one of demapper 202, demodulator/decoder 203, resource determiner 204, controller 205, control information holder 206, data/control information generator 207, encoder/modulator 208, and mapper 209 may be included in the controller illustrated in FIG. 4, and receiver 201 may be included in the receiver illustrated in FIG. 4.

Receiver 201 performs, for example, reception processing such as down-conversion or A/D conversion on a received signal received via an antenna, and outputs the received signal after the reception processing to demapper 202.

Demapper 202 performs, for example, resource demapping on the received signal input from receiver 201 based on the resource allocation information input from resource determiner 204, and outputs the modulated signal to demodulator/decoder 203.

Demodulator/decoder 203 demodulates and decodes, for example, the modulated signal input from demapper 202, and outputs the decoding result to resource determiner 204 and controller 205. The decoding result may include, for example, at least one of higher layer signaling information or downlink control information.

Resource determiner 204 determines, for example, the allocated resource based on the control information input from control information holder 206 or the decoding result of the control information input from demodulator/decoder 203, and outputs the resource allocation information to demapper 202.

Controller 205 may determine, for example, whether to transmit or receive data or control information based on the decoding result (for example, data or control information) input from demodulator/decoder 203 and the control information input from control information holder 206. Further, for example, in a case where the result of the determination is that there is a transmission of data or control information, controller 205 may give data/control information generator 207 an instruction to generate at least one of data and control information.

Control information holder 206 holds, for example, the control information input from controller 205, and outputs the held information to each component (for example, resource determiner 204 and controller 205), as needed.

For example, data/control information generator 207 generates data or control information in accordance with the indication from controller 205 and outputs a signal including the generated data or control information to encoder/modulator 208. The control information may include, for example, the UL-DL interference information measured by terminal 200 (for example, information on an interference level from an uplink to a downlink measured by terminal 200).

Encoder/modulator 208 encodes and modulates, for example, the signal input from data/control information generator 207, and outputs the modulated signal to mapper 209.

Mapper 209 performs resource mapping on the modulated signal input from encoder/modulator 208, and outputs the transmission signal to transmitter 210.

Transmitter 210 performs, for example, transmission processing such as D/A conversion, up-conversion, or amplification on the signal input from mapper 209, and transmits the radio signal obtained by the transmission processing to base station 100 from the antenna.

### [Operations of Base Station 100 and Terminal 200]

Exemplary operations of base station 100 and terminal 200 having the above configurations will be described.

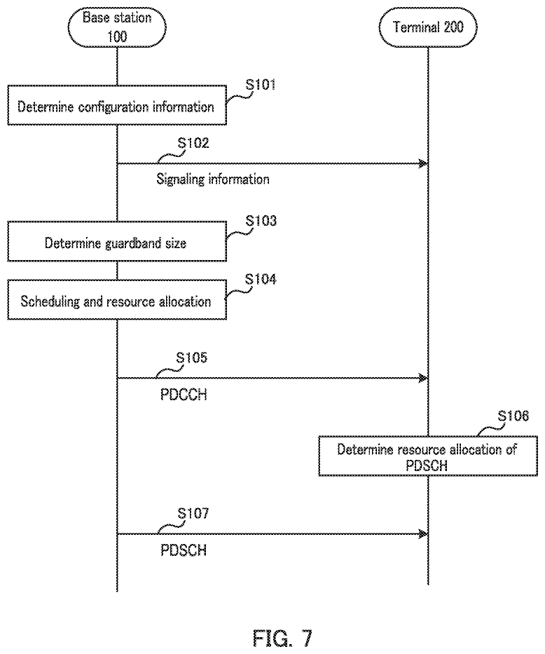

FIG. 7 is a sequence diagram illustrating an exemplary operation of base station 100 and terminal 200.

In FIG. 7, base station 100 determines, for example, information on the configuration for SBFD or resource allocation (S101).

Base station 100 transmits, to terminal 200, higher layer signaling information including, for example, determined configuration information (S102).

Base station 100 determines, for example, the guardband size to be used for the downlink reception by terminal 200 or the uplink reception by base station 100 based on the CLI or the like for terminal 200 (S103).

Base station 100 performs, for example, scheduling of the transmission of the downlink data (for example, PDSCH) and resource allocation for terminal 200 based on the configured guardband size (S104).

Base station 100 transmits, for example, a downlink control signal (for example, a physical downlink control channel (PDCCH)) based on the scheduling result (S105).

Terminal 200 specifies (or determines/identifies) the resource allocation (time-frequency resource) for the downlink data (for example, PDSCH) based on, for example, the PDCCH transmitted from base station 100 (S106).

Base station 100 transmits the downlink data (for example, PDSCH) in accordance with the scheduling result, and terminal 200 receives the downlink data (for example, PDSCH) based on the determined resource allocation (S107).

### [Resource Allocation Method]

The resource allocation method in base station 100 (for example, resource controller 105) will be described. Terminal 200 (for example, resource determiner 204) may determine the resources allocated by assuming the resource allocation method performed by base station 100.

Hereinafter, an example of the resource allocation method will be described.

In the following description, as an example, an example of the resource allocation for a non-contiguous DL subband configuration {DUD} will be described. In addition, base station 100 applies, for example, RA type 1 to the resource allocation of the PDSCH. In this case, base station 100 transmits control information to terminal 200, including information (for example, RBₛₜₐᵣₜ) on a start position of the RB (for example, VRB) including at least the DL subband and the number of RBs (for example, the number of VRBs, L_{RB}) contiguous from the start position.

### <Method 1>

As a method of performing non-contiguous resource allocation to the DL subband using RA type 1, Method 1 defines a VRB that does not include the UL subband and the guardband (for example, a VRB composed only of the RBs of the DL subband).

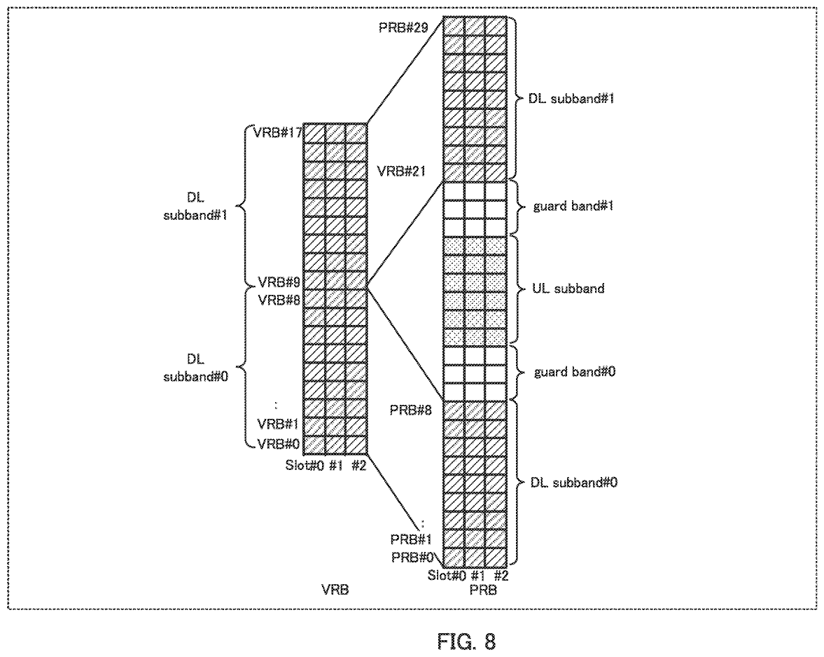

FIG. 8 illustrates an example of VRBs composed of DL subbands and not including the UL subband and the guardband.

In the VRB illustrated in FIG. 8, an index is allocated to RBs (for example, 18 RBs) constituting the DL subbands (for example, DL subbands #0 and #1). That is, in FIG. 8, the index of the VRB is not allocated to any RB constituting the UL subband and any guardband.

The VRB illustrated in FIG. 8 includes the RBs of the DL subband and does not include the RBs of the UL subband and the guardband, so that when performing the mapping from the VRB to the PRB, the RBs (VRBs) of the DL are mapped to the PRBs of the DL. For example, in FIG. 8, VRBs #0 to #8 are mapped to PRBs #0 to #8 of DL subband #0, and VRBs #9 to #17 are mapped to PRB #21 to #29 of DL subband #1.

By defining the VRB composed of the RBs of the DL subband in this manner, even in a case where the resource allocation (for example, RA type 1) of contiguous RBs on the VRB is performed, non-contiguous resource allocation on the PRB is possible. Thus, the non-contiguous allocation to the DL subband using existing RA type 1 can be performed.

Here, in the above method, the guardband size is not adjusted. For example, as in Adjustment Method 1 for adjusting the guardband size described above, it is assumed that the guardband is expanded by not allocating resources to the DL subband. As an example, in FIG. 8, it is assumed that the resources are not allocated to the PRBs adjacent to the guardbands in the DL subbands (for example, PRB #8 and PRB #21). In this case, in order to allocate resources to the entire DL subband, base station 100 allocates resources while avoiding VRB #8 and VRB #9 corresponding to PRB #8 and PRB #21. However, in RA type 1, since base station 100 performs resource allocation to contiguous RBs, it is difficult to allocate resources while avoiding VRB #8 and VRB #9.

Therefore, in the above method, it is difficult to achieve both non-contiguous resource allocation to the DL subband and adjustment of the guardband size.

Therefore, in Method 1, for example, the order of mapping from the VRBs to the PRBs is changed. For example, in a case where the DL subbands are non-contiguously arranged in SBFD, base station 100 causes the order in which a plurality of DL subbands are mapped in the VRB to differ from the order in which the plurality of DL subbands are mapped in the PRB. For example, the order in which the subbands are arranged on the VRB and the order in which the subbands are arranged on the PRB may be switched.

For example, some VRBs that are contiguous from the first VRB (VRB #0) and belong to the same subband as the first VRB may be mapped to PRBs (for example, adjacent PRBs) contiguous from the last RB of the guardband in the PRB (for example, RB on a boundary with the DL subband). In addition, for example, some VRBs that are contiguous from the last VRB and belong to the same subband as the last VRB may be mapped to PRBs (for example, adjacent PRBs) contiguous from the last RB of the guardband in the PRB (for example, RB on a boundary with the DL subband).

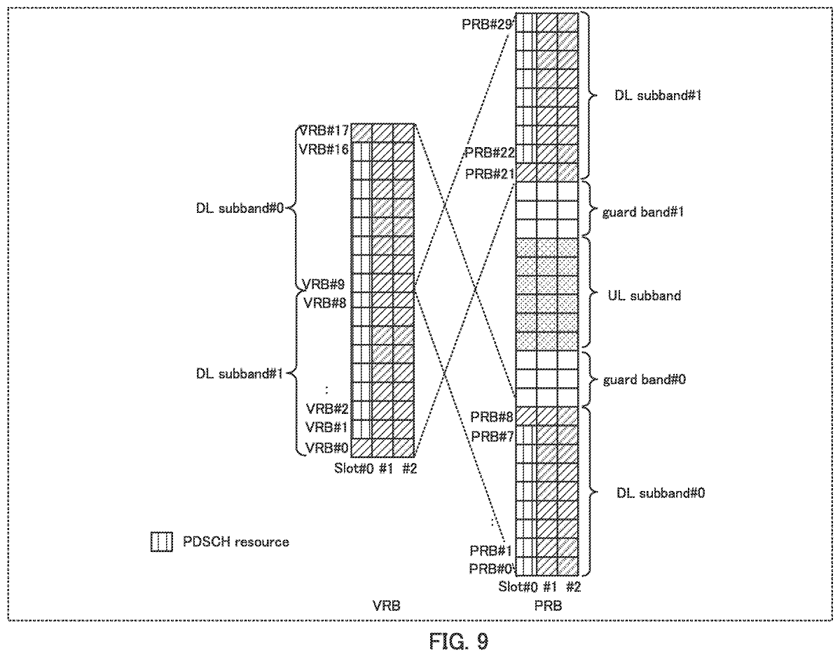

FIG. 9 illustrates an example of VRBs including the DL subbands and having a switched mapping order.

In the example of FIG. 9, the RBs of the VRB are mapped in an order of {DL subband #1, DL subband #0} in the PRB. Therefore, the order in which the subbands are arranged on the VRB {DL subband #1, DL subband #0} is different from the order in which the subbands are arranged on the PRB {DL subband #0, DL subband #1}.

In addition, as illustrated in FIG. 9, RBs (for example, VRB #0 and VRB #17) located at the ends of the VRBs are mapped to PRBs (for example, PRB #21 and PRB #8) adjacent to the guardbands in the PRBs. For example, VRB #0, which is a start position of the VRB, and VRB #17, which is an end position of the VRB, are mapped to PRB #21 and PRB #8, which are positions adjacent to the guardbands in the PRBs, respectively.

As illustrated in FIG. 9, since PRB #8 and PRB #21 are PRBs close to the UL subband among the PRBs constituting the DL subbands, the influence of the CLI is likely to be larger than the influence on the other PRBs constituting the DL subbands. That is, the CLI from the UL subband has a characteristic of being larger at the RBs located at the ends of the VRBs compared to the RBs located at the center of the VRB. This characteristic is effective when performing contiguous resource allocation such as in RA type 1, and when using the RBs of the DL subband as the guardbands based on the CLI.

In FIG. 9, in the VRB, slot #0 and VRB #1 to VRB #16 are allocated to the PDSCH resources, and VRB #0 and VRB #17 are not allocated to the PDSCH resources. In this case, as illustrated in FIG. 9, when mapping from the VRB to the PRB, PRB #0 to PRB #7 and PRB #21 to PRB #29 are allocated to the PDSCH resources in the PRBs. In this case, as illustrated in FIG. 9, in a case where PRB #8 and PRB #21 corresponding to VRB #0 and VRB #17, respectively, are not used in other terminals, these PRBs can be used as substantial guardbands. Therefore, in the example of FIG. 9, in slot #0, four RBs can be used as the guardbands between DL subband #0 and the UL subband, and between DL subband #1 and the UL subband.

By changing the mapping order in this way, it is possible to achieve both non-contiguous resource allocation to the DL subband and adjustment of the guardband size.

In FIG. 9, an example in which the VRB includes the DL subbands and does not include the guardband has been described, but the present invention is not limited to this, and for example, the VRB may include the DL subbands and the guardband.

Hereinafter, a case where the VRB includes the DL subbands and the guardband and does not include the UL subband will be described.

For example, some VRBs that are contiguous from the first VRB (VRB #0) and belong to the same guardband as the first VRB and each of the DL subbands contiguous to the guardband may be mapped to PRBs (for example, adjacent PRBs) contiguous from the last RB of the UL subband in the PRBs (for example, RB on a boundary with the guardband). In addition, for example, some VRBs that are contiguous from the last VRB and belong to the same guardband as the last VRB and each of the DL subbands contiguous to the guardband may be mapped to PRBs (for example, adjacent PRBs) contiguous from the last RB of the UL subband in the PRBs (for example, RB on a boundary with the guardband).

By including the DL subbands and the guardband in the VRBs, for example, by allocating DL resources to the RBs of the guardband as in Adjustment Method 2 for adjusting the guardband size, the guardband can be reduced.

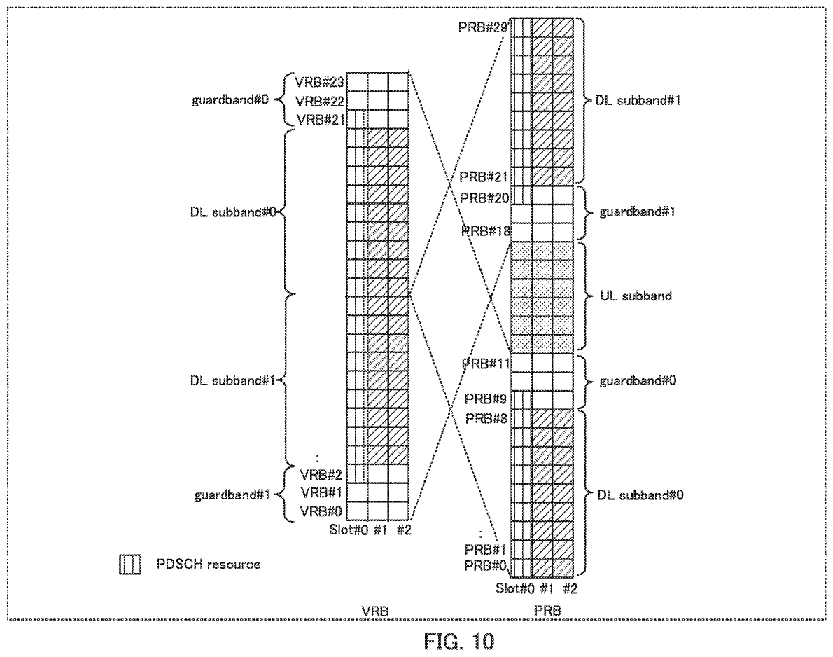

FIG. 10 illustrates an example of VRBs including the DL subbands and the guardbands and having a switched mapping order.

In the example of FIG. 10, the RBs of the VRB are mapped in an order of {guardband #1, DL subband #1, DL subband #0, guardband #0} for the PRB. Therefore, the order in which the DL subbands and the guardbands are arranged on the VRB {guardband #1, DL subband #1, DL subband #0, guardband #0} is different from the order in which the DL subbands and the guardbands are arranged on the PRB {DL subband #0, guardband #0, guardband #1, DL subband #1}.

In addition, as illustrated in FIG. 10, RBs (for example, VRB #0 and VRB #23) located at the ends of the VRBs are mapped to PRBs (for example, PRB #18 and PRB #11) adjacent to the UL subband in the PRBs. For example, VRB #0, which is a start position of the VRBs, and VRB #23, which is an end position of the VRBs, are mapped to PRB #18 and PRB #11, which are positions adjacent to the UL subband in the PRBs, respectively.

As illustrated in FIG. 10, since PRB #11 and PRB #18 are adjacent to the UL subband, the influence of the CLI is likely to be larger than the influence on the other PRBs constituting the DL subbands and the guardbands. That is, the CLI from the UL subband has a characteristic of being larger at the RBs located at the ends of the VRBs compared to the RBs located at the center of the VRB. This characteristic is effective when performing contiguous resource allocation such as in RA type 1, and when allocating and using resources (for example, DL resources) to the RBs in the guardband based on the CLI.

In FIG. 10, in the VRB, slot #0 and VRB #2 to VRB #21 are allocated to the PDSCH resources, and VRB #0, VRB #1, VRB #22, and VRB #23 are not allocated to the PDSCH resources. In this case, as illustrated in FIG. 10, when mapping from the VRB to the PRB, PRB #0 to PRB #9 and PRB #20 to PRB #29 are allocated to the PDSCH resources in the PRBs. In this case, as illustrated in FIG. 10, the PRB #9 and PRB #20 in the guardband are allocated to the PDSCH resources, so that the guardband can be considered to be reduced. Therefore, in the example of FIG. 10, in slot #0, two RBs can be used as the guardband between DL subband #0 and the UL subband, and between DL subband #1 and the UL subband.

By changing the mapping order in this way, it is possible to achieve both non-contiguous resource allocation to the DL subband and adjustment of the guardband size.

The VRB may include the DL subband, the UL subband, and the guardband (that is, all types of subbands).

Hereinafter, a case where the VRB includes the DL subband, the guardband, and the UL subband will be described. The UL subband may be located at the first RB of the VRBs or may be located at the last RB of the VRBs.

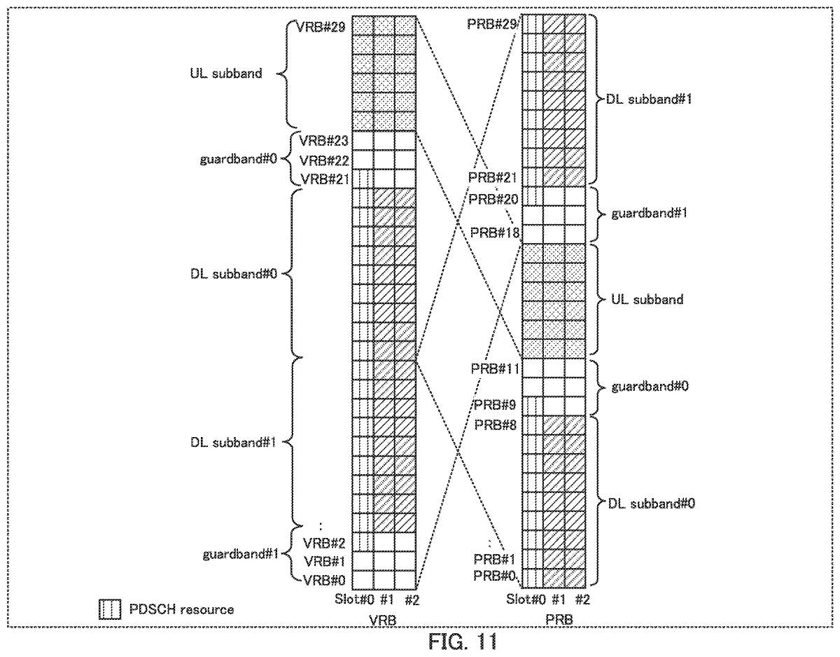

FIG. 11 illustrates an example of VRBs including the DL subbands, the UL subband, the guardbands, and having a switched mapping order.

In the example of FIG. 11, the RBs of the VRB are mapped in an order of {guardband #1, DL subband #1, DL subband #0, guardband #0, UL subband} for the PRB.

Therefore, the order in which the DL subbands, the UL subband, and the guardbands are arranged on the VRB {guardband #1, DL subband #1, DL subband #0, guardband #0, UL subband} is different from the order in which the DL subbands, the UL subband, and the guardbands are arranged on the PRB {DL subband #0, guardband #0, UL subband, guardband #1, DL subband #1}.

For example, VRB #0, which is a start position of the VRB, is mapped to PRB #18, which is a position adjacent to one end of the UL subband in the PRB, and VRB #29, which is an end position of the VRB, is mapped to PRB #17, which is the one end of the UL subband in the PRB.

As illustrated in FIG. 11, even in a case where the UL subband is included in the VRB, the guardband size can be adjusted while achieving the non-contiguous allocation to the DL subband, similar to a case where the DL subband and the guardband are included in the VRB. In addition, since the UL subband is also included in the VRB, in a case where the DL transmission and reception can be performed on the UL subband, the resource (for example, the PDSCH resource) can be allocated to the RB of the UL subband.

As described above, in Method 1, by switching the mapping order between the VRB and the PRB, both the non-contiguous resource allocation and the adjustment of the guardband size can be achieved even in the contiguous resource allocation such as in RA type 1, and the use efficiency of the resource can be improved.

In addition, in Method 1, since the existing indication method can be reused as RA type 1, the overhead of the downlink control information does not increase.

### <Method 2>

A description is given of Method 2 in which a function of rate matching is reused as one method for excluding an RB of the UL subband and the guardband from PRBs for resource allocation in a case where RA type 1 is applied.

The rate matching is, for example, a function of not allocating the PDSCH to some resources in order to avoid interference with other base stations. For example, the rate matching pattern (RateMatchPattern) can be configured by the signaling information from base station 100 to terminal 200, and a resource configured by the rate matching pattern (for example, a resource element (RE) designated by the RB number and/or the symbol number) can be configured not to be used for the transmission and reception of the PDSCH.

The rate matching may be applied not only to the resource designated by the rate matching pattern but also to, for example, an RB in which a synchronization signal (SS)/physical broadcast channel (PBCH) block (SSB) is transmitted.

In Method 2, by using the function of the rate matching, for example, the RBs of the UL subband or the guardband are treated (or explicitly configured) as resources that are not used for the transmission and reception of the PDSCH. As a result, for example, even in a case where the subband configuration is {DUD} and all the RBs including the UL subband and the guardband are configured by RA Type 1, the RBs of the DL subband are used for the transmission and reception of the PDSCH, and the RBs of the UL subband and the guardband are not used for the transmission and reception of the PDSCH. Therefore, it is possible to perform the non-contiguous resource allocation to the DL subband by using RA type 1.

When the RB of the guardband is configured as the resource that cannot be used for the transmission and reception of the PDSCH, Adjustment Method 2 for adjusting the guardband size (method of allocating the DL resource or the UL resource in the guardband) is not applicable. Therefore, for example, whether to apply the rate matching may be determined by using the following rules.

### <Rule 1>

In Rule 1, in a case where the DL subbands are non-contiguously arranged, base station 100 determines whether or not to apply the rate matching based on a start position or an end position of the resource allocation in the PRB.

For example, in a case where the terminal is indicated that the resource allocation of the PDSCH spans a plurality of DL subbands in the downlink control information (DCI), the UL subband and the guardband are not included in the actual resource of the PDSCH (for example, the rate matching is applied). For example, in a case where the start position and the end position of the resource allocation of the PDSCH (for example, RA type 1) are included respectively in the plurality of DL subbands that are non-contiguously arranged (for example, in a case where the start position and the end position of the resource allocation of the PDSCH span the plurality of DL subbands), base station 100 determines to apply the rate matching.

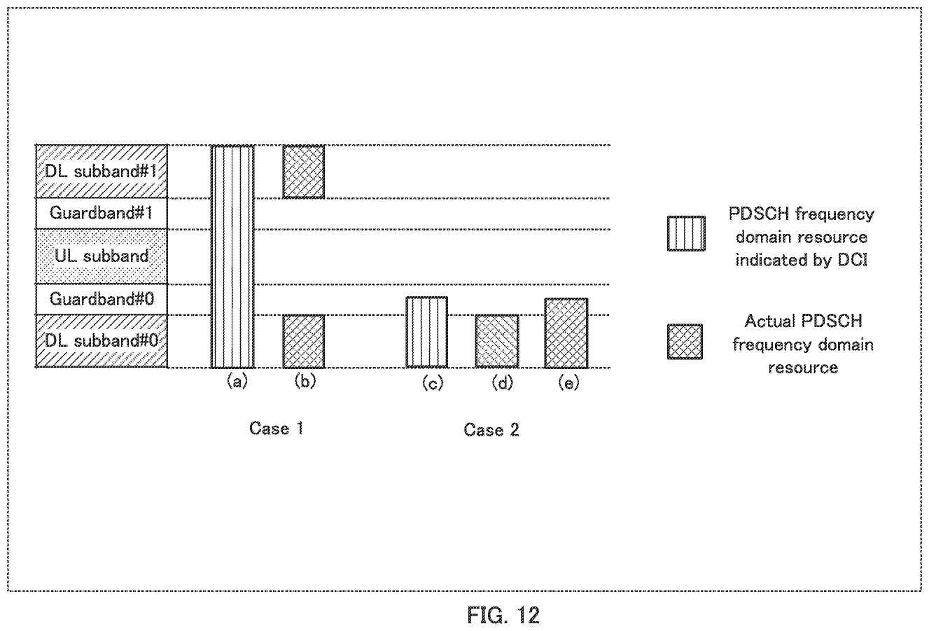

Case 1 of FIG. 12 illustrates an example to which Rule 1 is applied. In the examples of FIG. 12, examples of frequency resource allocation for the subband configuration of {DUD} are illustrated. For example, the indication of the resource allocation by the DCI illustrated at part (a) in FIG. 12 indicates the allocation of the PDSCH resource to the entire band spanning two DL subbands. That is, the start position of the resource allocation by the DCI illustrated at part (a) in FIG. 12 is included in DL subband #0, and the end position is included in DL subband #1.

Part (b) in FIG. 12 illustrates an example of the actual resource allocation of the PDSCH. By applying Rule 1, the rate matching is applied, so that the UL subband and the guardband are not included in the actual resource allocation of the PDSCH. Therefore, the resources excluding the resources corresponding to the UL subband and the guardband from the allocation of the PDSCH resource illustrated at part (a) in FIG. 12 are the actual resource allocation of the PDSCH.

In this way, by applying Rule 1, it is possible to simultaneously allocate the resources of the PDSCH to the non-contiguous DL subbands using RA type 1. This allows for efficient transmission and reception of data by allocating a large amount of resources in a case where the size of the data is large.

### <Rule 2>

In Rule 2, in a case where the DL subbands are non-contiguously arranged, base station 100 determines whether or not to apply the rate matching based on a start position or an end position of the resource allocation in the PRB.

For example, in a case where the terminal is indicated that the resource allocation of the PDSCH starts or ends in the guardband or in the UL subband in the downlink control information (DCI), the frequency resource indicated by the DCI is configured as the actual resource of the PDSCH (for example, the rate matching is not applied). For example, in a case where the start position or the end position of the resource allocation of the PDSCH (for example, RA type 1) is included in a band (for example, a guardband or a UL subband) different from the DL subband, base station 100 determines not to apply the rate matching.

Case 2 of FIG. 12 illustrates an example to which Rule 2 is applied.

The indication of the resource allocation by the DCI illustrated at part (c) in FIG. 12 indicates that the PDSCH resource starts from DL subband #0 and ends in the guardband #0.

Part (d) in FIG. 12 illustrates a case where Rule 1 is applied as an example. As illustrated at part (d) in FIG. 12, when Rule 1 is applied, the rate matching is applied, so that the resource in the guardband is not used for the PDSCH. In this case, the guardband size cannot be adjusted.

Part (e) in FIG. 12 illustrates a case where Rule 2 is applied. As illustrated at part (e) in FIG. 12, when Rule 2 is applied, the rate matching is not applied, so that the resource is allocated in the guardband. Therefore, for example, in a case where the CLI is small, the use efficiency of the resource can be improved by allocating the resource of the guardband to the PDSCH.

### <Rule 3>

In Rule 3, in a case where a frequency domain resource allocation (FDRA) field or an RIV is set to a specific value in the downlink control information (DCI), a semi-statically configured or pre-defined resource allocation is applied.

Here, the number of patterns of the values of the RIV depends on a combination of RBₛₜₐᵣₜ and L_{RB} in RA type 1. Therefore, there may be a case where the combination of RBₛₜₐᵣₜ and L_{RB} does not exist up to the maximum value for the number of bits allocated to the RIV. For example, in a case where the number of RBs of the BWP is 20, 8 bits are used for the RIV, so that 256 patterns can be indicated as the resource allocation. On the other hand, among 256 patterns, the number of patterns associated with the RIV is 210. Therefore, among the 256 patterns that can be indicated, 46 values of the RIV are not used.

Therefore, in Rule 3, for example, among the values represented by a plurality of bits used for indicating the RIV in RA type 1, values different from the values associated with the combinations of RBₛₜₐᵣₜ and L_{RB} indicated by the RIV are associated with the allocation patterns in the plurality of subbands.

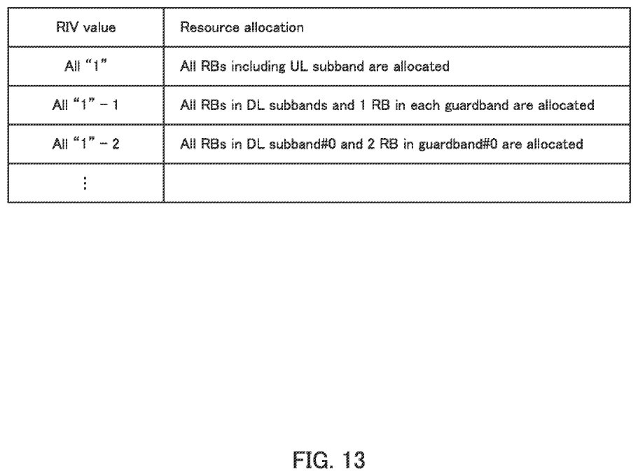

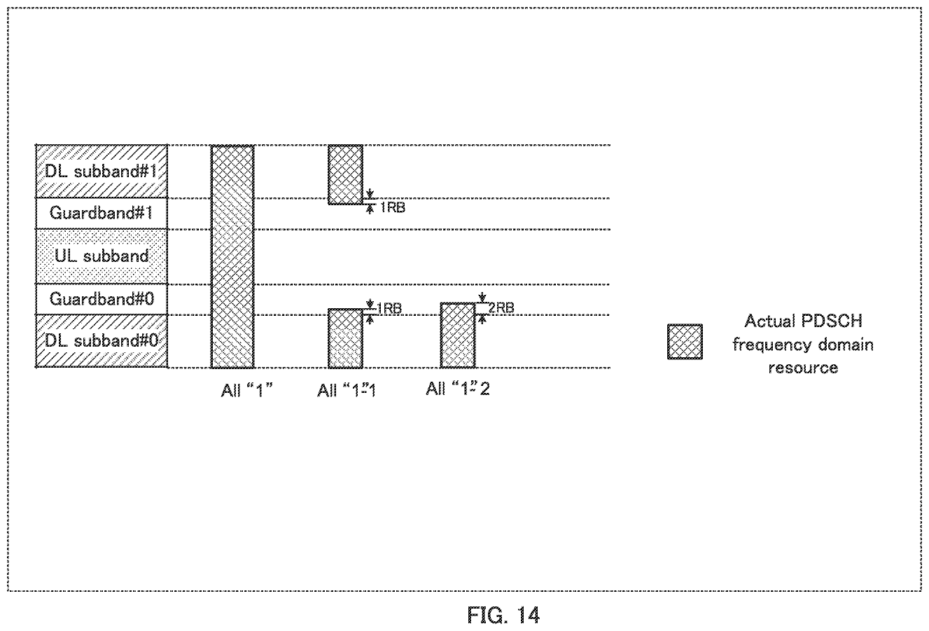

FIG. 13 illustrates examples of the resource allocation by specific patterns using the values of the RIV. In addition, FIG. 14 illustrates application examples of the resource allocation by the specific patterns using the values of the RIV illustrated in FIG. 13.

In FIG. 13, “All “1”” is intended to mean that the RIV value is 2N−1 (N is the bit length of the RIV). For example, in a case where the RIV is 8 bits (N=8), “All “1”” represents 255 (that is, 0b11111111). In the example of FIG. 13, “All “1”” is associated with the allocation of the PDSCH resource to all the RBs including the UL subband as illustrated in FIG. 14. For example, when Rule 1 is applied, the resource of the PDSCH cannot be allocated to the entire band, but in a case of “All “1””, the resource of the PDSCH can be allocated to the entire band.

In FIG. 13, “All “1”−1” is intended to mean that the RIV value is 2^{N}−2 (N is the bit length of the RIV). For example, in a case where the RIV is 8 bits (N=8), “All “1”−1” represents 254 (that is, 0b11111110). In the example of FIG. 13, “All “1”−1” is associated with the allocation of the PDSCH resource to all the RBs of the DL subbands (two DL subbands #0 and #1 in FIG. 14) and to one RB in each guardband (guardbands #0 and #1 in FIG. 14) as illustrated in FIG. 14.

In addition, in FIG. 13, “All “1”−2” is intended to mean that the RIV value is 2^{N}−3 (N is the bit length of the RIV). For example, in a case where the RIV is 8 bits (N=8), “All “1”−2” represents 253 (that is, 0b11111101). In the example of FIG. 13, “All “1”−2” is associated with the allocation of the PDSCH resource to all the RBs of DL subband #0 and two RBs in the guardband #0 as illustrated in FIG. 14.

As described above, by applying the resource allocation by the specific pattern, both the non-contiguous allocation and the adjustment of the guardband can be performed, so that the use efficiency of the resource can be improved. In addition, by configuring the specific pattern, it is possible to perform the resource allocation of a complex pattern that cannot be allocated in RA type 1, so that the use efficiency of the resource can be improved.

Rules 1 to 3 have been described above.

These rules may be applied in a case where two or more DL subbands and two or more guardbands are allocated, such as in a subband configuration {DUDUD}.

In addition, in the above description, the operation in which the resource is not allocated to the UL subband and the guardband by the rate matching has been described, but the present invention may be applied to methods other than the rate matching. For example, the above method can be applied to an operation in which the function of the rate matching is not used and the resource of the PDSCH is not allocated to the UL subband and the guardband.

In addition, base station 100 may apply at least two of Rules 1 to 3 in a switching manner depending on a certain condition.

As described above, in Method 2, even in the contiguous resource allocation such as in RA type 1, the non-contiguous resource allocation and the adjustment of the guardband size can be achieved, and the use efficiency of the resource can be improved. In addition, since the existing indication of RA type 1 can be reused, the DCI overhead does not increase. In addition, in Method 2, since additional VRB to PRB mapping is not required, the complexity can be reduced as compared to Method 1.

Method 1 and Method 2 related to the resource allocation have been described above.

As described above, in the present embodiment, in SBFD in which the transmission direction is configured for each of the plurality of subbands into which the frequency band is divided, base station 100 and terminal 200 cause the resource allocation to vary depending on whether the DL subbands are non-contiguously arranged in the PRB. For example, base station 100 and terminal 200 may cause the VRB-PRB mapping to vary between a case where the DL subbands are non-contiguously arranged and a case where the DL subbands are not non-contiguously arranged. Alternatively, in a case where the DL subbands are non-contiguously arranged, base station 100 and terminal 200 may determine whether to apply the rate matching depending on the resource allocation of the PDSCH.

As a result, for example, even in a case where the resource allocation of the contiguous RBs by RA type 1 is applied, the resource can be simultaneously allocated to the plurality of non-contiguous DL subbands. In addition, for example, even in a case where RA type 1 is applied, it is possible to select the VRB position such that the resource is not allocated on the UL subband.

In addition, for example, even in a case where the resource allocation to the contiguous RBs is performed as in RA type 1, it is possible to adjust the guardband size, such as the expansion of the guardband or the reduction of the guardband. Accordingly, for example, it is possible to perform the non-contiguous resource allocation to the DL subbands and appropriately adjust the guardband size according to the CLI, so that the use efficiency of the resource can be improved.

Therefore, according to the present embodiment, it is possible to appropriately control the resource allocation in the radio communication.

### OTHER EMBODIMENTS

In the above-described embodiment, a case where Method 1 and Method 2 are applied to the resource allocation of the PDSCH has been described, but Method 1 and Method 2 may be applied to uplink data (for example, PUSCH). In the PUSCH, RA type 1 and VRB-to-PRB mapping can also be used. Therefore, in a case where a plurality of UL subbands are supported, the resource allocation may be difficult, as in the case of PDSCH. In this case, Method 1 or Method 2 may be applied to the PUSCH by replacing the PDSCH with the PUSCH, switching the DL subband with the UL subband, and switching the reception with the transmission.

In addition, in the above-described embodiment, a case where RA type 1 is applied has been described, but the exemplary embodiment of the present disclosure may be applied, without being limited to RA type 1, as long as a method of allocating the contiguous resources is used.

In addition, in the above-described embodiment, a case where SBFD is applied has been described, but the exemplary embodiment of the present disclosure may be applied without being limited to SBFD as long as the transmission direction (for example, DL or UL) is configured for the plurality of bands (for example, subbands) into which the frequency band is divided.

In addition, in the above-described embodiment, values such as the number of subbands, the number of DL subbands, the number of UL subbands, the number of guardbands, the number of RBs (the number of VRBs or the number of PRBs), the number of slots, the RIV value, and the number of bits used to indicate the RIV are merely examples and are not limited. In addition, the subband configuration (for example, {DUD}) used in the above-described embodiment is merely an example, and the number of subbands and the arrangement order of the DL subbands and the UL subbands are not limited thereto.

### SUPPLEMENTARY NOTE

Information indicating whether terminal 200 supports the functions, operations, or pieces of processing that have been indicated in the above-mentioned embodiments may be transmitted (or indicated) from terminal 200 to base station 100, as capability information or a capability parameter for terminal 200, for example.

The capability information may include an information element (IE) individually indicating whether terminal 200 supports at least one of the functions, operations, or processes described in the above-described embodiments. Alternatively, the capability information may include an information element indicating whether terminal 200 supports a combination of any two or more of the functions, operations, and processing described in the above embodiments.

Base station 100 may determine (or assume) the function, operation, or process supported (or not supported) by terminal 200 of the transmission source of the capability information, based on the capability information received from terminal 200, for example.

Base station 100 may execute operations, processes, or control in accordance with a determination result based on the capability information. For example, base station 100 may control resource allocation for terminal 200 based on the capability information received from terminal 200.

Note that the fact that terminal 200 does not support some of the functions, operations, or processes described in the above-described embodiments may be read as that some of the functions, operations, or processes are limited in terminal 200. For example, information or a request relating to such limitation may be indicated to base station 100.

The information on the capability or the limitation of terminal 200 may be defined by standards or may be implicitly indicated to base station 100 in association with information known in base station 100 or information to be transmitted to base station 100, for example.

### (Control Signals)

In the present disclosure, the downlink control signal (or downlink control information) relating to the exemplary embodiment of the present disclosure may be a signal (or information) transmitted in a Physical Downlink Control Channel (PDCCH) in a physical layer, for example, or may be a signal (or information) transmitted in a Medium Access Control Control Element (MAC CE) or Radio Resource Control (RRC) in a higher layer. Further, the signal (or information) is not limited to that indicated by the downlink control signal, but may be predefined in the specifications (or standard) or may be pre-configured for the base station and the terminal.

In the present disclosure, an uplink control signal (or uplink control information) relating to an exemplary embodiment of the present disclosure may be, for example, a signal (or information) transmitted through a PUCCH of the physical layer or a signal (or information) transmitted through the MAC CE or RRC of the higher layer. Further, the signal (or information) is not limited to that indicated by the uplink control signal, and may be predefined in the specifications (or standard) or may be pre-configured for the base station and the terminal. The uplink control signal may be replaced with, for example, uplink control information (UCI), 1st stage sidelink control information (SCI), or 2nd stage SCI.

### (Base Station)

In one exemplary embodiment of the present disclosure, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Further, in sidelink communication, a terminal may play a role of a base station. Furthermore, instead of the base station, a relay apparatus that relays communication between a higher node and a terminal may be used. Moreover, a road side device may be used.

### (Uplink/Downlink/Sidelink)

An exemplary embodiment of the present disclosure may be applied to, for example, any of an uplink, a downlink, and a sidelink. For example, an exemplary embodiment of the present disclosure may be applied to an uplink Physical Uplink Shared Channel (PUSCH), Physical Uplink Control Channel (PUCCH), or Physical Random Access Channel (PRACH), a downlink Physical Downlink Shared Channel (PDSCH), PDCCH, or Physical Broadcast Channel (PBCH), or a sidelink Physical Sidelink Shared Channel (PSSCH), Physical Sidelink Control Channel (PSCCH), or Physical Sidelink Broadcast Channel (PSBCH).

Note that the PDCCH, the PDSCH, the PUSCH, and the PUCCH are examples of a downlink control channel, a downlink data channel, an uplink data channel, and an uplink control channel, respectively. Further, the PSCCH and the PSSCH are examples of a sidelink control channel and a sidelink data channel, respectively. Further, the PBCH and PSBCH are examples of broadcast channels, and the PRACH is an example of a random access channel.

### (Data Channels/Control Channels)

An exemplary embodiment of the present disclosure may be applied to, for example, any of a data channel and a control channel. For example, a channel in an exemplary embodiment of the present disclosure may be replaced with any one of the PDSCH, the PUSCH, and the PSSCH being the data channels, or the PDCCH, the PUCCH, the PBCH, the PSCCH, and the PSBCH being the control channels.

### (Reference Signals)

In an exemplary embodiment of the present disclosure, a reference signal is a signal known to both of a base station and a mobile station, for example, and may also be referred to as a Reference Signal (RS) or a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### (Time Intervals)

In one exemplary embodiment of the present disclosure, the units of time resources are not limited to one or a combination of slots and symbols, but may be time resource units such as, for example, frames, superframes, subframes, slots, time slot subslots, minislots, or symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### (Frequency Bands)

An exemplary embodiment of the present disclosure may be applied to either a licensed band or an unlicensed band.

### (Communication)

An exemplary embodiment of the present disclosure may be applied to any of communication between a base station and a terminal (Uu link communication), communication between a terminal and a terminal (Sidelink communication), and communication of a Vehicle to Everything (V2X). For example, a channel in an exemplary embodiment of the present disclosure may be replaced with any of PSCCH, PSSCH, Physical Sidelink Feedback Channel (PSFCH), PSBCH, PDCCH, PUCCH, PDSCH, PUSCH, and PBCH.

Further, one exemplary embodiment of the present disclosure may be applied to any of a terrestrial network or a network (Non-Terrestrial Network (NTN)) other than a terrestrial network using a satellite or a High Altitude Pseudo Satellite (HAPS). Further, an exemplary embodiment of the present disclosure may be applied to a network having a large cell size, and a terrestrial network with a large latency compared with a symbol length or a slot length, such as an ultra-wideband transmission network.

### (Antenna Ports)

In an exemplary embodiment of the present disclosure, an antenna port refers to a logical antenna (antenna group) formed of one or more physical antenna(s). For example, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

### <5G NR System Architecture and Protocol Stack>

3GPP has been working on the next release for the 5th generation cellular technology (simply called “5G”), including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones).

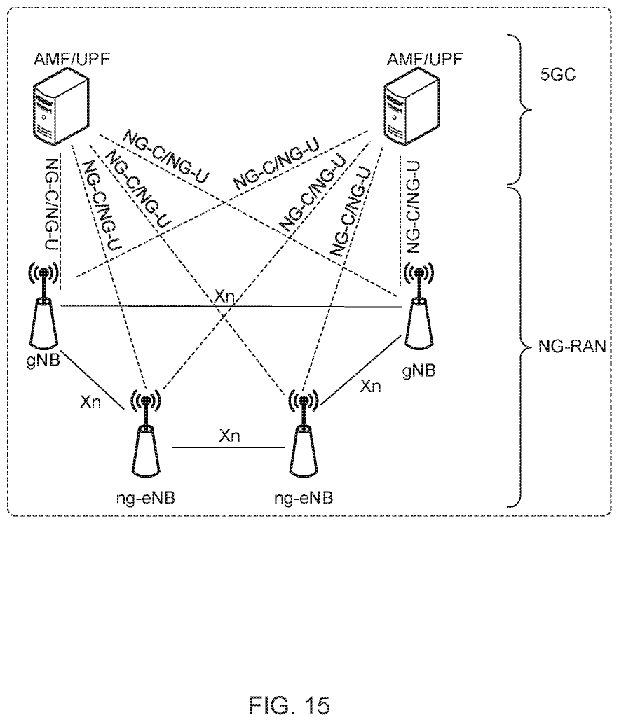

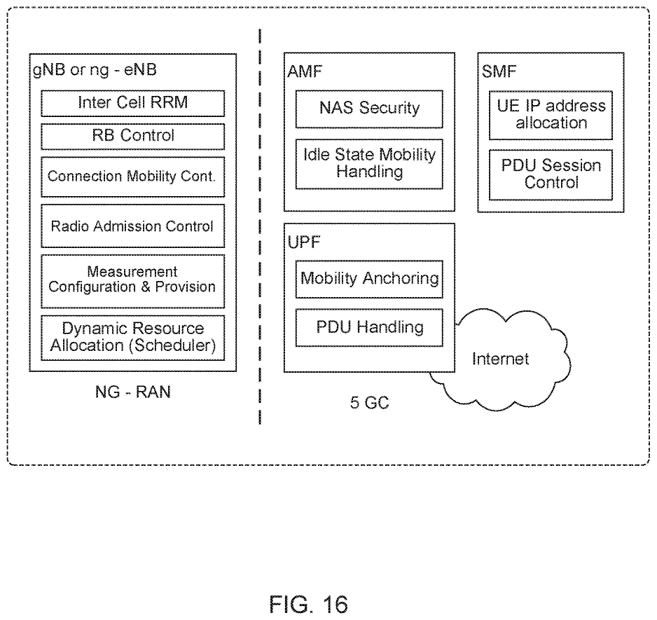

For example, the overall system architecture assumes an NG-RAN (Next Generation-Radio Access Network) that includes gNBs. The gNB provides the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture is illustrated in FIG. 15 (see e.g., 3GPP TS 38.300 v15.6.0, section 4). The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side.

Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates on the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, the mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, and number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, and 60 kHz . . . are being considered at the moment. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR for each numerology and each carrier, resource grids of subcarriers and OFDM symbols are defined respectively for uplink and downlink. Each element in the resource grids is called a resource element and is identified based on the frequency index in the frequency domain and the symbol position in the time domain (see 3GPP TS 38.211 v15.6.0).

### <Functional Split Between NG-RAN and 5GC in 5G NR>

FIG. 16 illustrates the functional split between the NG-RAN and the 5GC. A logical node of the NG-RAN is gNB or ng-eNB. The 5GC includes logical nodes AMF, UPF, and SMF.

For example, gNB and ng-eNB hosts the following main functions:
Radio Resource Management functions such as Radio Bearer Control, Radio Admission Control, Connection Mobility Control, and dynamic allocation (scheduling) of both uplink and downlink resources to a UE;
IP header compression, encryption, and integrity protection of data;
Selection of an AMF during UB attachment in such a case when no routing to an AMF can be determined from the information provided by the UE;
Routing user plane data towards the UPF;
Routing control plane information towards the AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session management;
Support of network slicing;
QoS flow management and mapping to data radio bearers;
Support of UEs in the RRC_INACTIVE state;
Distribution function for NAS messages;
Radio access network sharing;
Dual connectivity; and
Tight interworking between NR and E-UTRA.

The Access and Mobility Management Function (AMF) hosts the following main functions:
Function of Non-Access Stratum (NAS) signaling termination;
NAS signaling security;
Access Stratum (AS) security control;
Inter-Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing;
Session Management Function (SMF) selection.

In addition, the User Plane Function (UPF) hosts the following main functions:
Anchor Point for intra-/inter-RAT mobility (when applicable);
External Protocol Data Unit (PDU) session point for interconnection to a data network;
Packet routing and forwarding;
Packet inspection and a user plane part of Policy rule enforcement;
Traffic usage reporting;
Uplink classifier to support routing traffic flows to a data network;
Branching point to support multi-homed PDU session;
QoS handling for user plane (e.g., packet filtering, gating, UL/DL rate enforcement);
Uplink traffic verification (SDF to QoS flow mapping); and
Function of downlink packet buffering and downlink data notification triggering.

Finally, the Session Management Function (SMF) hosts the following main functions:
Session management;
UE IP address allocation and management;
Selection and control of UPF;
Configuration function for traffic steering at the User Plane Function (UPF) to route traffic to a proper destination;
Control part of policy enforcement and QoS; and
Downlink data notification.

### <RRC Connection Setup and Reconfiguration Procedure>

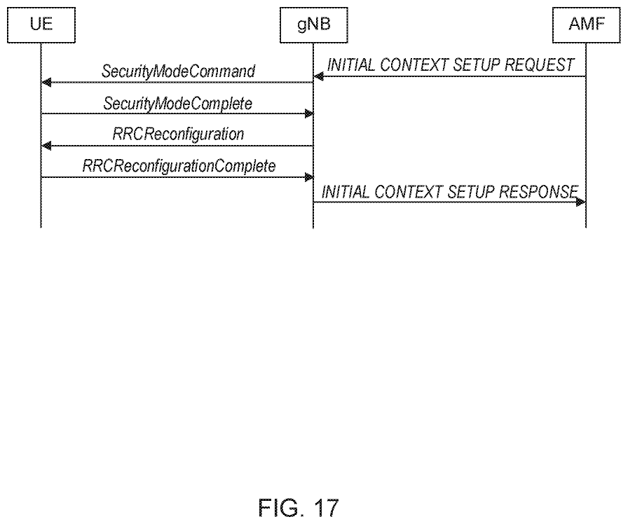

FIG. 17 illustrates some interactions between a UE, gNB, and AMF (a 5GC Entity) performed in the context of a transition of the UE from RRC_IDLE to RRC_CONNECTED for the NAS part (see TS 38 300 v15.6.0).

The RRC is higher layer signaling (protocol) used to configure the UE and gNB. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a Security ModeCommand message and by the UE responding to the gNB with the SecurityModeComplete message. Afterwards, the gNB performs the reconfiguration to setup the Signaling Radio Bearer 2 (SRB2) and Data Radio Bearer(s) (DRB(s)) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB indicates the AMF that the setup procedure is completed with INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### <Usage Scenarios of IMT for 2020 and Beyond>

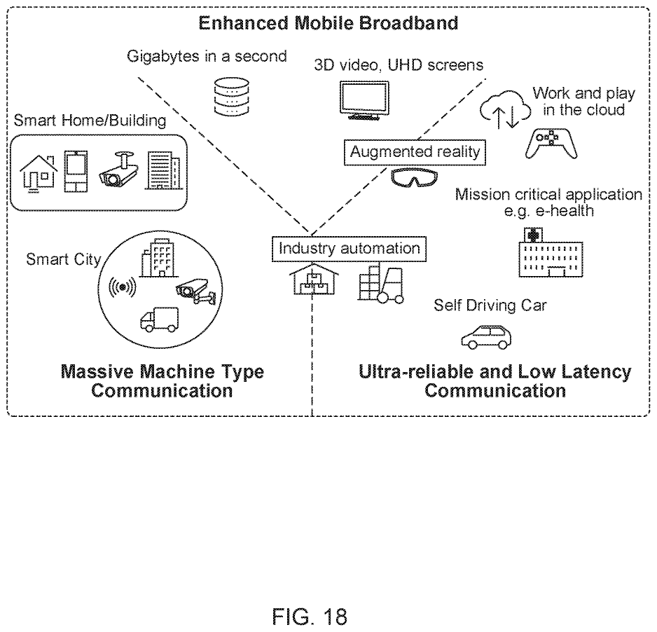

FIG. 18 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 18 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of IE-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for the URLLC and mMTC for example, is high reliability or ultra-reliability. Several mechanisms can improve the reliability from radio perspective and network perspective. In general, there are a few key potential areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been envisioned such as factory automation, transport industry and electrical power distribution. The tighter requirements are higher reliability (up to 10-6 level), higher availability, packet size of up to 256 bytes, time synchronization down to the order of a few us where the value can be one or a few us depending on frequency range and short latency in the order of 0.5 to 1 ms (e.g., target user plane latency of 0.5 ms) depending on the use cases.

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### <QoS Control>

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU sessions. For each UE, the NG-RAN establishes at least one Data Radio Bearer (DRB) together with the PDU session, e.g., as illustrated above with reference to FIG. 17. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

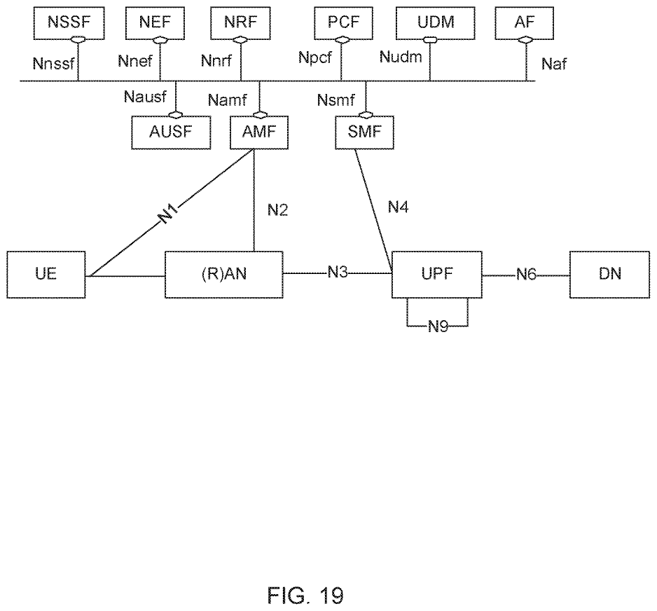

FIG. 19 illustrates a 5G NR non-roaming reference architecture (see TS 23.501 v16.1.0, section 4.23). An Application Function (AF) (e.g., an external application server hosting 5G services, exemplarily described in FIG. 18) interacts with the 3GPP Core Network in order to provide services, for example to support application influencing on traffic routing, accessing Network Exposure Function (NEF) or interacting with the policy framework for policy control (e.g., QoS control) (see Policy Control Function, PCF). Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 19 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN, e.g., operator services, Internet access, or third party services). All of or a part of the core network functions and the application services may be deployed and running on cloud computing environments.

In the present disclosure, thus, an application server (e.g., AF of the 5G architecture), is provided that includes: a transmitter, which in operation, transmits a request containing a QoS requirement for at least one of URLLC, eMMB and mMTC services to at least one of functions (such as NEF, AMF, SMF, PCF, and UPF) of the 5GC to establish a PDU session including a radio bearer between a gNodeB and a UE in accordance with the QoS requirement; and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smartphone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as, e.g., a base station, an access point, and any other apparatus, device or system that communicates with or controls apparatuses such as those in the above non-limiting examples.

A base station according to one exemplary embodiment of the present disclosure includes: control circuitry, which, in operation, causes resource allocation to vary depending on whether a first band corresponding to a first transmission direction is non-contiguously arranged in a physical resource block, in a scheme in which a transmission direction is configured for each of a plurality of bands into which a frequency band is divided; and transmission circuitry, which, in operation, transmits a signal in accordance with the resource allocation.

In one exemplary embodiment of the present disclosure, the transmission circuitry transmits control information on the resource allocation including a start position of a virtual resource block and a number of virtual resource blocks that are contiguous from the start position, the virtual resource block including at least the first band, and in a case where a plurality of the first bands are non-contiguously arranged, the control circuitry causes an order in which the plurality of first bands are mapped in the virtual resource block to differ from an order in which the plurality of first bands are mapped in the physical resource block.

In one exemplary embodiment of the present disclosure, the virtual resource block includes the first band, and does not include a second band and a guardband between the first band and the second band, the second band corresponding to a second transmission direction different from the first transmission direction, and the start position and an end position of the virtual resource block are mapped to positions adjacent to the guardband in the physical resource block.

In one exemplary embodiment of the present disclosure, the virtual resource block includes the first band and a guardband between the first band and a second band corresponding to a second transmission direction different from the first transmission direction, and does not include the second band, and the start position and an end position of the virtual resource block are mapped to positions adjacent to the second band in the physical resource block.

In one exemplary embodiment of the present disclosure, the virtual resource block includes the first band, a second band corresponding to a second transmission direction different from the first transmission direction, and a guardband between the first band and the second band, and the start position is mapped to a position adjacent to one end of the second band in the physical resource block, and an end position of the virtual resource block is mapped to the one end of the second band in the physical resource block.

In one exemplary embodiment of the present disclosure, in a case where a plurality of the first bands are non-contiguously arranged, the control circuitry determines whether or not to apply rate matching based on a start position or an end position of the resource allocation in the physical resource block.

In one exemplary embodiment of the present disclosure, in a case where the start position and the end position are included in each of the plurality of first bands, the control circuitry determines to apply the rate matching.

In one exemplary embodiment of the present disclosure, in a case where the start position or the end position is included in a band different from the first band, the control circuitry determines not to apply the rate matching.

In one exemplary embodiment of the present disclosure, the transmission circuitry transmits control information on the resource allocation including a start position of a virtual resource block and a number of virtual resource blocks that are contiguous from the start position, the virtual resource block including at least the first band, and among values represented by a plurality of bits used for indicating the control information, a value different from a value associated with a combination of the start position and the number of virtual resource blocks is associated with an allocation pattern in the plurality of bands.

A terminal according to one exemplary embodiment of the present disclosure includes: control circuitry, which, in operation, causes resource allocation to vary depending on whether a first band corresponding to a first transmission direction is non-contiguously arranged in a physical resource block, in a scheme in which a transmission direction is configured for each of a plurality of bands into which a frequency band is divided; and reception circuitry, which, in operation, receives a signal in accordance with the resource allocation.

A communication method for a base station according to one exemplary embodiment of the present disclosure includes: causing resource allocation to vary depending on whether a first band corresponding to a first transmission direction is non-contiguously arranged in a physical resource block, in a scheme in which a transmission direction is configured for each of a plurality of bands into which a frequency band is divided; and performing transmission or reception of a signal in accordance with the resource allocation.

A communication method for a terminal according to one exemplary embodiment of the present disclosure includes: causing resource allocation to vary depending on whether a first band corresponding to a first transmission direction is non-contiguously arranged in a physical resource block, in a scheme in which a transmission direction is configured for each of a plurality of bands into which a frequency band is divided; and receiving a signal in accordance with the resource allocation.

The disclosure of Japanese Patent Application No. 2023-021552, filed on Feb. 15, 2023, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100 Base station
101, 201 Receiver
102, 202 Demapper
103, 203 Demodulator/decoder
104 Scheduler
105 Resource controller
106, 206 Control information holder
107, 207 Data/control information generator
108, 208 Encoder/modulator
109, 209 Mapper
110, 210 Transmitter
200 Terminal
204 Resource determiner
205 Controller

1. A base station, comprising:
control circuitry, which, in operation, causes resource allocation to vary depending on whether a first band corresponding to a first transmission direction is non-contiguously arranged in a physical resource block, in a scheme in which a transmission direction is configured for each of a plurality of bands into which a frequency band is divided; and
transmission circuitry, which, in operation, transmits a signal in accordance with the resource allocation.

2. The base station according to claim 1, wherein:
the transmission circuitry transmits control information on the resource allocation including a start position of a virtual resource block and a number of virtual resource blocks that are contiguous from the start position, the virtual resource block including at least the first band, and
in a case where a plurality of the first bands are non-contiguously arranged, the control circuitry causes an order in which the plurality of first bands are mapped in the virtual resource block to differ from an order in which the plurality of first bands are mapped in the physical resource block.

3. The base station according to claim 2, wherein:
the virtual resource block includes the first band, and does not include a second band and a guardband between the first band and the second band, the second band corresponding to a second transmission direction different from the first transmission direction, and
the start position and an end position of the virtual resource block are mapped to positions adjacent to the guardband in the physical resource block.

4. The base station according to claim 2, wherein:
the virtual resource block includes the first band and a guardband between the first band and a second band corresponding to a second transmission direction different from the first transmission direction, and does not include the second band, and
the start position and an end position of the virtual resource block are mapped to positions adjacent to the second band in the physical resource block.

5. The base station according to claim 2, wherein;
the virtual resource block includes the first band, a second band corresponding to a second transmission direction different from the first transmission direction, and a guardband between the first band and the second band, and
the start position is mapped to a position adjacent to one end of the second band in the physical resource block, and an end position of the virtual resource block is mapped to the one end of the second band in the physical resource block.

6. The base station according to claim 1, wherein
in a case where a plurality of the first bands are non-contiguously arranged, the control circuitry determines whether or not to apply rate matching based on a start position or an end position of the resource allocation in the physical resource block.

7. The base station according to claim 6, wherein
in a case where the start position and the end position are included in each of the plurality of first bands, the control circuitry determines to apply the rate matching.

8. The base station according to claim 6, wherein
in a case where the start position or the end position is included in a band different from the first band, the control circuitry determines not to apply the rate matching.

9. The base station according to claim 1, wherein:
the transmission circuitry transmits control information on the resource allocation including a start position of a virtual resource block and a number of virtual resource blocks that are contiguous from the start position, the virtual resource block including at least the first band, and
among values represented by a plurality of bits used for indicating the control information, a value different from a value associated with a combination of the start position and the number of virtual resource blocks is associated with an allocation pattern in the plurality of bands.

10. A terminal, comprising:
control circuitry, which, in operation, causes resource allocation to vary depending on whether a first band corresponding to a first transmission direction is non-contiguously arranged in a physical resource block, in a scheme in which a transmission direction is configured for each of a plurality of bands into which a frequency band is divided; and
reception circuitry, which, in operation, receives a signal in accordance with the resource allocation.

11. A communication method for a base station, comprising:
causing resource allocation to vary depending on whether a first band corresponding to a first transmission direction is non-contiguously arranged in a physical resource block, in a scheme in which a transmission direction is configured for each of a plurality of bands into which a frequency band is divided; and
performing transmission or reception of a signal in accordance with the resource allocation.

12. A communication method for a terminal, comprising:
causing resource allocation to vary depending on whether a first band corresponding to a first transmission direction is non-contiguously arranged in a physical resource block, in a scheme in which a transmission direction is configured for each of a plurality of bands into which a frequency band is divided; and
receiving a signal in accordance with the resource allocation.
